(19) United States
(12) Patent Application Publication
(10) Pub. No.: US 2009/0174604 A1
(43) Pub. Date: Jul. 9, 2009

(54) Internal Multiband Antenna and Methods

(76) Inventors: Pasi Keskitalo, Oulu (FI); Pekka Pussinen, Oulu (FI)

Correspondence Address: GAZDZINSKI & ASSOCIATES, 11440 WEST BERNARDO COURT, SUITE 375, SAN DIEGO, CA, 92127, US

(21) Appl. No.: 11/922,976

(22) PCT Filed: Nov. 15, 2005
(86) PCT No.: PCT/FI2005/050414

§ 371 Date: Jan. 26, 2009

(30) Foreign Application Priority Data
Jun. 28, 2005 (FI) 20055353

(51) Int. Cl. H01Q 5/01; H01Q 1/36; H01Q 1/48

(52) U.S. Cl. 343/700 MS; 343/833; 343/848

(57) ABSTRACT

A multiband antenna intended for small-sized radio devices, internal to the device. The antenna comprises a main element (320) connected to the antenna feed conductor (326) and a short-circuited parasitic element (330). The feed point (FP) is beside the short-circuit point (S1) of the parasitic element. The elements are typically elongated, and at least their parts, which correspond a certain operating band, are substantially perpendicular to each other. Two resonances, the frequencies of which fall on two different operating bands of the antenna, are excited also in the parasitic element. In order to implement the resonances of the parasitic element, the coupling between the elements takes place through a very narrow slot (309) near the feed point and the short-circuit point of the parasitic element. The coupling is then sufficiently strong in spite of the positions of the main and the parasitic element. Even the lower operating band of the antenna can be made so wide that it covers the frequency ranges of two different systems.

The invention relates to an internal multiband antenna intended for small-sized radio devices, in which antenna a parasitic element is utilized. The invention also relates to a radio device with an antenna according to it.

Models that operate in two ore more systems using different frequency ranges, such as different GSM systems (Global System for Mobile telecommunications) have become more common in mobile stations. The basic condition for the operation of the mobile station is that the radiation and receiving characteristics of its antenna are satisfactory in the frequency bands of all the systems in use. Without any limit on size, it is relatively easy to make a high-quality multiband antenna. However, in mobile stations, especially mobile phones, the antenna must be small when it is placed inside the cover of the device for convenience of use. This makes designing the antenna a more demanding task.

In practice, an antenna of sufficiently high quality that can be placed inside a small device can be most easily implemented as a planar structure. The antenna includes a radiating plane and a ground plane parallel with it. For matching, the radiating plane and the ground plane are generally connected to each other by a short-circuit conductor, in which case a structure of the PIFA (Planar Inverted F-Antenna) type is created. The number of operating bands can be increased to two by dividing the radiating plane by means of a non-conductive slot into two branches of different length as seen from the short-circuit point, in a way that the resonance frequencies of the antenna parts corresponding to the branches fall on the ranges of the desired frequency bands. However, it is then difficult to make a single operating band so wide that it would cover the frequency ranges used by two radio systems. For example, GSM1800 and GSM1900 form such a pair of systems. The matching of the antenna in this respect can be improved by increasing the number of antenna elements. An electromagnetically coupled, i.e. parasitic element is placed near the radiating plane proper. Its resonance frequency is arranged suitably close to the upper resonance frequency of the PIFA, for example, in order to widen the upper operating band.

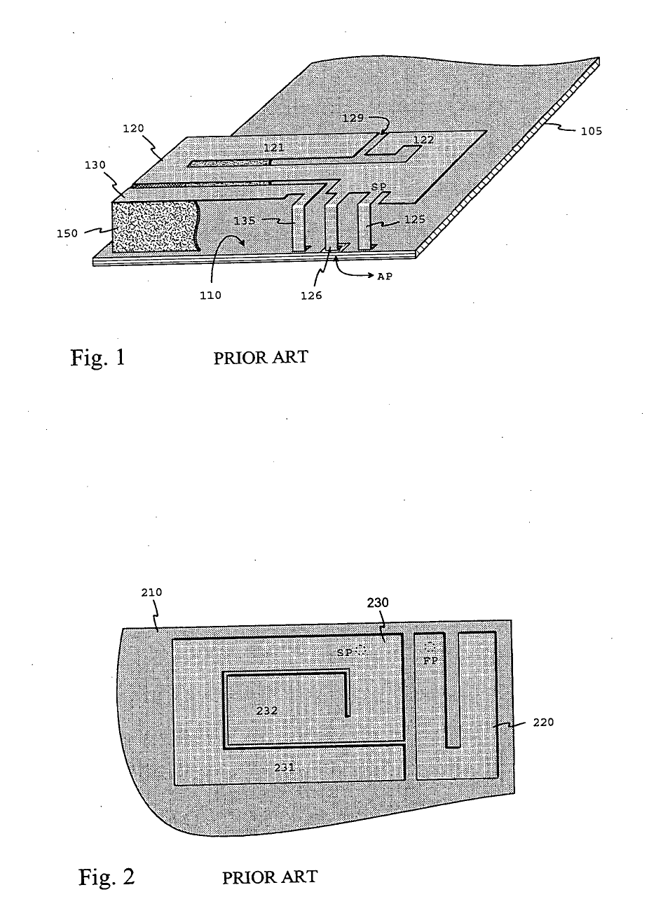

FIG. 1 presents such a known internal multiband antenna. The circuit board 105 of a radio device, the upper surface of which board is conductive, is in the drawing. This conductive surface functions as the ground plane 110 of the planar antenna. At one end of the circuit board there is the radiating plane 120 of the antenna, the outline of which resembles a rectangle and which is supported above the ground plane by a dielectric frame 150. The short-circuit conductor 125 that connects the radiating plane to the ground plane and the feed conductor 126 of the whole antenna start from an edge of the radiating plane, close to one of its corners. From the feed conductor, insulated from the ground, there is a through hole to the antenna port AP on the lower surface of the circuit board 105. The radiating plane 120 has been shaped by means of a slot 129 therein so that the plane is divided into two conductor branches of clearly different length as seen from its short-circuit point SP, the PIFA in question thus having two bands. The lower operating band is based on the first, longer conductor branch 121, and the upper operating band is based on the second, shorter conductor branch 122. In addition, the antenna includes a radiating parasitic element 130. This is a planar conductive object in the same geometrical plane as the radiating plane 120. The parasitic element is located beside the radiating plane on its long side next to the first portion of the first conductor branch mentioned above. Further, the parasitic element is connected to the ground by its own short-circuit conductor 135 at the end on the side of the antenna feed conductor 126. Together with the surrounding structure, the parasitic element forms a resonator, the natural frequency of which is in the frequency range of the GSM1900 system, for example. If in this case the natural frequencies of the PIFA have been arranged in the ranges of the GSM900 and GSM1800 systems, for example, the result is an antenna that operates in three systems.

The antenna according to FIG. 1 has the drawback that it is difficult to use the parasitic element for widening the lower operating band of the antenna. Exciting two resonances in the parasitic element in a way that it would be utilized both on the lower and upper band is not at all possible. Thus the antenna is not suitable for a radio device, which should operate in two systems using the lower operating band. In addition, especially the lower resonance frequency of the PIFA is susceptible to external conductive substances. Therefore, the user's hand may cause the relatively narrow lower operating band to shift partly outside the frequency range of the radio system being used.

FIG. 2 presents another example of an internal multiband planar antenna known from the publication EP 1128466. The antenna is drawn from above. Above the ground plane 210 on the same height there are the planar antenna feed element 220 and the planar parasitic element 230. The feed element is connected to the antenna port of a radio device from the feed point FP, and the parasitic element is connected to the ground plane from the short-circuit point SP. In this solution, the parasitic element is the main radiator of the antenna. It has a non-conductive slot, which divides the element into two branches of different length as seen from the short-circuit point SP. The PIFA structure based on the parasitic element is thus a dual-band structure. The feed element has two functions: It transfers energy to the field of the parasitic element via the electromagnetic coupling, and in addition functions as an auxiliary radiator in the upper operating band of the antenna. The structure is characterized in that only the parasitic element is short-circuited, which solution aims at maintaining the polarization of the radiation within the upper operating band. This antenna, too, has a relatively narrow lower operating band and the drawbacks resulting from this.

The object of the invention is to reduce said drawbacks of the prior art. The antenna according to the invention is characterized in what is set forth in the independent claim 1. Some preferred embodiments of the invention are set forth in the other claims.

The basic idea of the invention is the following: The multiband antenna comprises a main element connected to the antenna feed conductor and a short-circuited parasitic element. The feed point is beside the short-circuit point of the parasitic element. The elements are typically elongated and at least their parts, which correspond a certain operating band, are substantially perpendicular to each other. Two resonances are excited in both radiating elements, i.e. in the parasitic element as well, the frequencies of which fall on the two different operating bands of the antenna. In order to implement the resonances of the parasitic element the coupling between the elements takes place through a very narrow slot near the feed point and the short-circuit point of the parasitic element. The coupling is then sufficiently strong in spite of the positions of the main and the parasitic element.

The invention has the advantage that the lower operating band of the antenna can be made to cover the frequency ranges used by the US-GSM and the EGSM (Extended GSM) systems, for example. This means that an additional antenna or a switch arrangement in the antenna is avoided, when the radio device has to operate in two systems using the lower operating band in addition to the systems using the upper bands. The width of the lower operating band is based on the fact that the lower resonance frequencies of the main and the parasitic element can be arranged at a suitable distance from each other. In addition, the invention has the advantage that a shifting of the lower operating band of the antenna by the effect of external objects, above all the hand of the user of the device, does not cause trouble, when the radio device has to operate in only one system using the lower operating band. This is due to that the band in question provides room for shifting because of its wideness. Yet another advantage of the invention is that the upper operating band of the antenna can also be made wide.

In the following, the invention will be described in more detail. Reference will be made to the accompanying drawings, in which

FIG. 1 shows an example of a prior art internal multiband antenna,

FIG. 2 shows another example of a prior art internal multiband antenna.

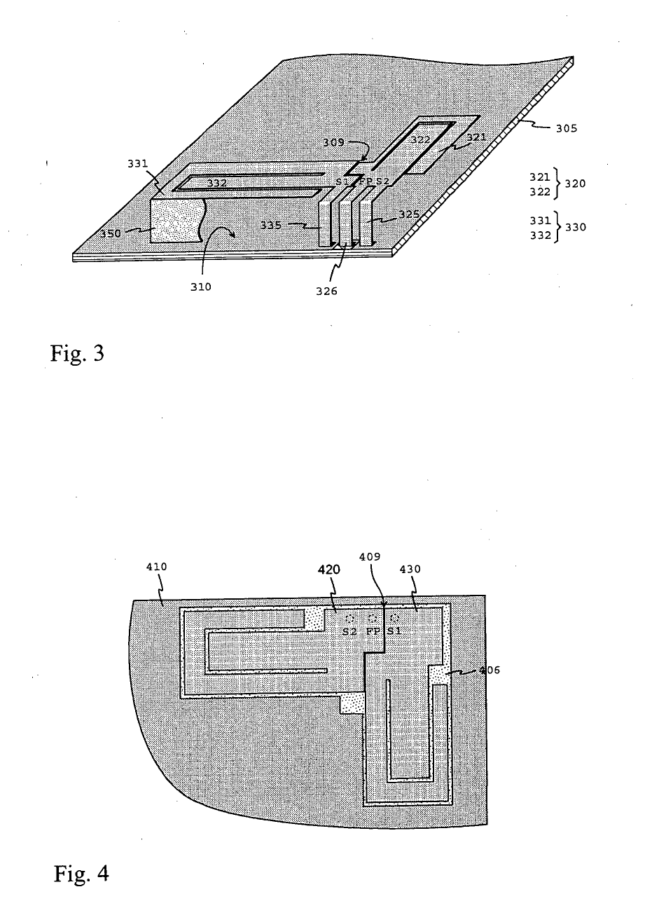

FIG. 3 shows an example of an internal multiband antenna according to the invention,

FIG. 4 shows a second example of an internal multiband antenna according to the invention,

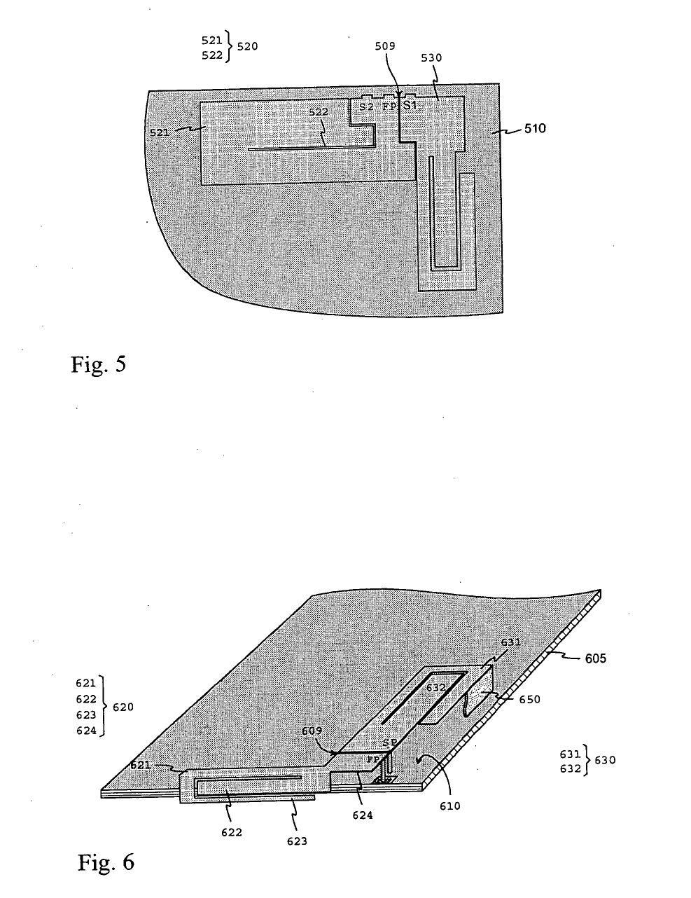

FIG. 5 shows a third example of an internal multiband antenna according to the invention,

FIG. 6 shows a fourth example of an internal multiband antenna according to the invention,

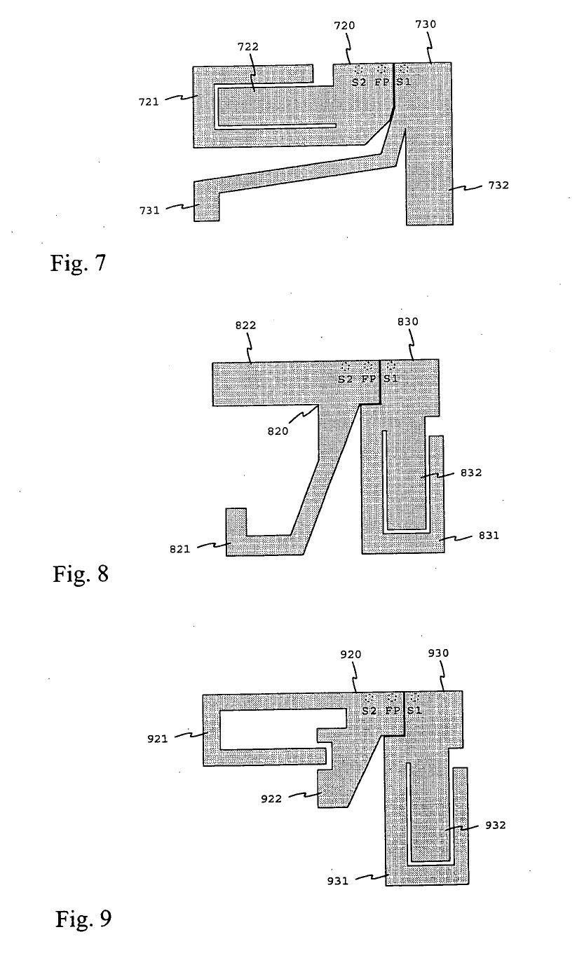

FIG. 7 shows a fifth example of an internal multiband antenna according to the invention,

FIG. 8 shows a sixth example of an internal multiband antenna according to the invention,

FIG. 9 shows a seventh example of an internal multiband antenna according to the invention,

FIG. 10 shows an eighth example of an internal multiband antenna according to the invention,

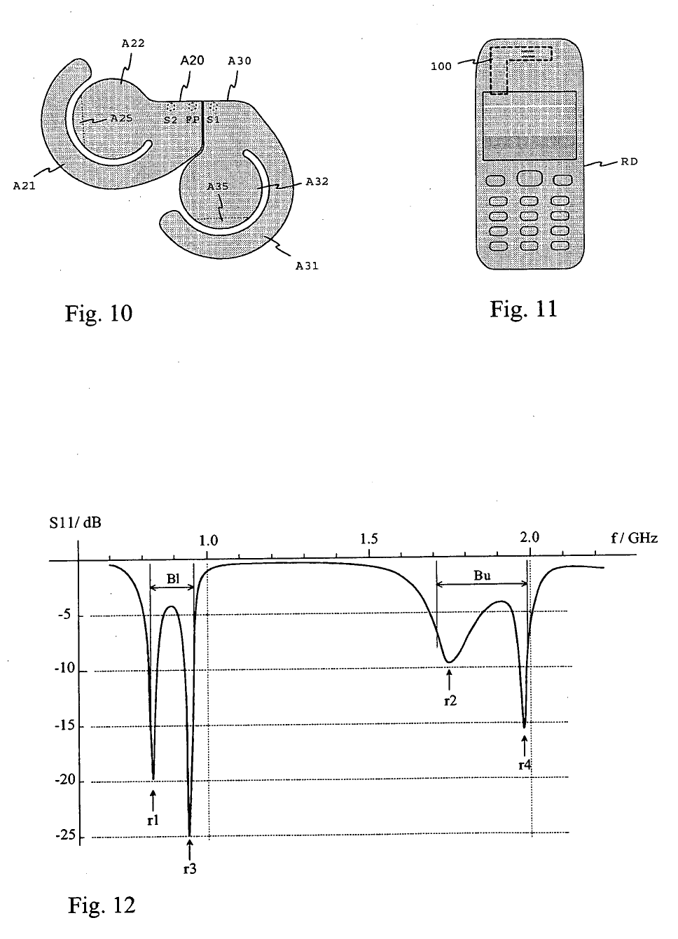

FIG. 11 shows an example of a radio device according to the invention, and

FIG. 12 shows an example of the matching of the antenna according to the invention.

FIGS. 1 and 2 were already discussed in connection with the description of the prior art.

FIG. 3 presents an example of a multiband antenna according to the invention, internal to the radio device. The antenna has two operating bands in this example, the lower and the upper, but the number of the bands used by different radio systems, in which the antenna operates, is larger. A rectangular circuit board 305 of the radio device, the conductive upper surface of which functions as the ground plane 310 of the antenna, is seen in the drawing. Above the ground plane there are the two planar radiating elements of the antenna substantially in the same geometrical plane: the main element 320 and the parasitic element 330. The main element is connected to the antenna port of the radio device by the feed conductor 326 and to the ground plane by the second short-circuit conductor 325, thus forming a PIFA together with the ground plane. The feed conductor joins the main element at the feed point FP and the second short-circuit conductor at the second short-circuit point S2. The main element has a non-conductive slot starting from its edge so that it is divided into two branches of different length as seen from the second short-circuit point. The second, shorter branch 322 is straight, and in this example it runs in the direction of the long side of the circuit board 305. The first, longer branch 321 resembles a rectangular letter U. It encircles mostly of the second branch 322, comprising a first portion running beside the second branch, a second portion running beside the end of the second branch and a third portion running beside the second branch on its opposite side. The third portion ends in the free end of the first branch. The parasitic element 330 is connected to the ground plane by the first short-circuit conductor 335, which joins the parasitic element at the first short-circuit point S1. The parasitic element also has a non-conductive slot starting from its edge so that it is divided into two branches of different length, the third and the fourth branch, as seen from the first short-circuit point. The fourth, shorter branch 332 is straight, and in this example it runs in the direction of the end of the circuit board 305. The third, longer branch 331 resembles a rectangular letter U. It encircles mostly of the fourth branch, comprising a first portion running beside the fourth branch, a second portion running beside the end of the fourth branch and a third portion running beside the fourth branch on its opposite side. The third portion ends in the free end of the third branch.

In the main element of the above-described structure the first branch 321 has a major direction, which points vertically from the feed point FP towards the second portion of the first branch. The second branch 322 has a major direction, which is its longitudinal direction and is in this example same as the major direction of the first branch. Correspondingly, in the parasitic element the third branch 331 has a major direction, which points vertically from the first short-circuit point S1 towards the second portion of the third branch. The fourth branch 332 has a major direction, which is its longitudinal direction and is in this example same as the major direction of the third branch. The major direction of the first and second branch is substantially perpendicular to the major direction of the third and fourth branch, which matter is one of the features of the invention.

The feed point FP is between the first S1 and the second S2 short-circuit point relatively close to each one. With regard to the function of the parasitic element 330, it is important that the starting portion of the main element 320 as seen from the feed point and the starting portion of the parasitic element as seen from the first short-circuit point are relatively close to each other. In FIG. 3, there is a slot 309 between these starting portions, which then is very narrow. The width of the slot 309 is e.g. 0.2 mm, and it is at the most of the same order of magnitude as one hundredth of the wavelength corresponding to the highest operating frequency of the antenna. The narrow slot provides a sufficiently strong coupling between the elements in spite of their perpendicular position in relation to each other.

By means of the described structure the resonances with frequencies that fall both on the lower and upper operating band of the antenna can be excited, besides in the main element, also in the parasitic element. The first 321 as well as the third 331 radiating branch together with the surrounding parts of the antenna form a resonator having its natural frequency in the lower operating band of the antenna. The natural frequencies of resonators based on the first and the third branch are arranged suitably different so that a relatively wide, united lower operating band is achieved. Correspondingly, the second 322 as well as the fourth 332 radiating branch together with the surrounding parts of the antenna forms a resonator having its natural frequency in the upper operating band of the antenna. The natural frequencies of resonators based on the second and the fourth branch are arranged suitably different so that a relatively wide, united upper operating band is achieved.

In the example of FIG. 3, the antenna feed conductor and the second short-circuit conductor are of the same metal sheet with the main element 320, and correspondingly the first short-circuit conductor is of the same sheet with the parasitic element. At the same time, the conductors function as springs, and in the mounted antenna their lower ends press against the circuit board 305 by spring force. A small part of the dielectric support structure 350 supporting the radiating elements is also seen in the drawing.

More generally, the “major direction” of a radiating part means in this description and claims, regarding the main element, a direction from the feed point towards the place nearest to the feed point of the farthest area of the radiating part. Correspondingly, the “major direction” of a radiating part means, regarding the parasitic element, a direction from the first short-circuit point towards the place nearest to the first short-circuit point of the farthest area of that part. The “farthest area” means an area farthest away from the feed/short-circuit point, which can be outlined recognizably. For example, the farthest area of a radiating part, which resembles letters U or J, is its transverse portion, from both ends of which starts a portion approximately towards the feed/short-circuit point. The farthest area of a radiating part resembling a rectangle is its outer end. “Substantially perpendicular to” means such an angle between two major directions that the coupling between the radiating parts corresponding those major directions occurs largely only over the narrow slot between the elements. In practice, this is the case, if the angle between the major directions is e.g. at least 60 degrees.

FIG. 4 shows another example of a multiband antenna according to the invention, internal to the radio device. The antenna is depicted from above. It has a main element 420 and a parasitic element 430, both of which have two radiating branches shaped in a similar way as in FIG. 3. The difference compared to FIG. 3 is that the radiators are now conductive areas on the upper surface of a small antenna circuit board 406. The board 406 is supported at a suitable distance from the ground plane 410. In this example, too, the outline of the main and the parasitic element forms an elongated pattern. The major direction of the longer branch of the main element is perpendicular to the major direction of the longer branch of the parasitic element, and likewise the major direction of the shorter branch of the main element is perpendicular to the major direction of the shorter branch of the parasitic element. The elements are separated by a narrow slot 409 running between the feed point FP of the antenna and the short-circuit point S1 of the parasitic element. The conductors to the feed point FP, the short-circuit point S2 of the main element and the short-circuit point S1 of the parasitic element are connected through the vias in the antenna circuit board.

FIG. 5 shows a third example of a multiband antenna according to the invention, internal to the radio device. The antenna is depicted from above. It has a main element 520 and a parasitic element 530 in the same plane at a right angle to each other, like in FIG. 3. The parasitic element has two radiating branches shaped in a similar way as in FIGS. 3 and 4. The main element also has a slot 522 starting from its edge. This slot has been shaped so that a resonance arises in it when the antenna is fed by certain frequencies of its upper operating band. The slot 522 thus functions as a radiator, or a radiator part, in the upper operating band. Together with the ground plane and other conductors nearby, the conductor plane 521 of the main element, circling round the slot, forms a resonator, which radiates in the lower operating band of the antenna. The major direction of the conductor plane 521 of the main element is perpendicular to the major direction of the longer branch of the parasitic element. The elements are separated by a narrow slot 509 running between the feed point FP of the antenna and the short-circuit point S1 of the parasitic element.

Also in the parasitic element, or only in it, the part resonating in the upper operating band may be a radiating slot instead of a radiating conductor branch.

FIG. 6 shows a fourth example of a multiband antenna according to the invention, internal to the radio device. In the drawing there is a rectangular circuit board 605 of a radio device, the conductive upper surface of which functions as the ground plane 610 of the antenna. Above the ground plane there is the parasitic element 630 belonging to the antenna. This is connected to the ground plane from the short-circuit point SP. The parasitic element has a non-conductive slot starting from its edge so that it is divided, as seen from the short-circuit point SP, into two radiating branches of different length, which have been shaped in a similar way as in the previous examples. In this example the major direction of the branches of the parasitic element is the same as the direction of the long side of the circuit board 605. The main element 620 is of the monopole type in this example. It has a coupling portion 624 on the level of the parasitic element, in which portion the antenna feed point FP is located. This is close to the short-circuit point SP of the parasitic element, and a narrow slot 609 separating the elements runs between these points. The coupling portion 624 of the main element extends outside the ground plane 610 as seen from above. The main element continues from the outer end of the coupling portion in the direction of the end of the circuit board 605 by a relatively narrow portion 621 on the level of the parasitic element. This is joined by a portion, which also runs in the direction of the end of the circuit board, but is directed towards the geometrical plane of the circuit board. This portion has a non-conductive slot starting from its edge, which divides the main element, as seen from the feed point FP, into two branches of different length for implementing two operating bands. The longer branch is formed of the above mentioned portion 621 and its extension 623. The longer branch encircles the end of the shorter branch 622.

Congruent with the description above the angle between the major direction of the longer branch of the main element and the major direction of the longer branch of the parasitic element, as well as the angle between the major direction of the shorter branch of the main element and the major direction of the shorter branch of the parasitic element, is somewhat greater than 90 degrees. However, the major directions in question are substantially perpendicular to each other also in this example.

The parasitic element may also be at least partly outside the ground plane as seen in the direction of the normal of the ground plane.

In FIGS. 7, 8, 9 and 10 there are four additional examples of the multiband antenna according to the invention. Only the radiating elements have been drawn in the figures, the whole antenna can be implemented e.g. like in FIG. 3 or in FIG. 4. The main element 720 of the antenna presented in FIG. 7 comprises a first 721 and a second 722 radiating branch shaped in a similar way as in FIGS. 3 and 4. Also the parasitic element 730 comprises two radiating branches. The major direction of the fourth branch 732 of these branches, corresponding to the upper operating band, is substantially perpendicular to the major direction of the second branch 722, like in FIGS. 3 and 4. Instead, most of the third branch 731 belonging to the parasitic element and corresponding to the lower operating band is directed away from all other branches. For this reason its major direction is not substantially perpendicular to the major direction of the first branch 721.

FIG. 8 shows a sixth example of a multiband antenna according to the invention. The parasitic element 830 comprises a third 831 and a fourth 832 radiating branch shaped in a similar way as in FIGS. 3 and 4. Also the main element 820 comprises two radiating branches. The major direction of the second branch 822 of these branches, corresponding to the upper operating band, is substantially perpendicular to the major direction of the fourth branch 832, like in FIGS. 3 and 4. Instead, most of the first branch 821 belonging to the main element and corresponding to the lower operating band is directed away from all other branches. For this reason its major direction is not substantially perpendicular to the major direction of the third branch 831.

FIG. 9 shows a seventh example of a multiband antenna according to the invention. The parasitic element 930 comprises a third 931 and a fourth 932 radiating branch shaped in a similar way as in FIGS. 3 and 4. Also the main element 920 comprises two radiating branches. The major direction of the first branch 921 of these branches, corresponding to the lower operating band, is substantially perpendicular to the major direction of the third branch 931. Instead, the second branch 922 belonging to the main element and corresponding to the upper operating band is not in this case located inside the figure formed by the first branch, but is directed through the gap between its free end and the parasitic element away from all other branches. For this reason the major direction of the second branch is not substantially perpendicular to the major direction of the fourth branch 932.

FIG. 10 shows an eighth example of a multiband antenna according to the invention. In the main element A20 the second radiating part A22 is formed almost entirely of a circular conductive area. Likewise in the parasitic element A30 the fourth radiating part A32 is formed almost entirely of a circular conductive area. The farthest area A25, A35 of the second and fourth radiating part is a relatively narrow segment of circle farthest away from the feed/short-circuit point. Congruent with the definition of the major direction, the major directions of the second and fourth radiating part are in that case substantially perpendicular to each other. Both the first radiating part A21 of the main element corresponding to the lower operating band and the third radiating part A31 of the parasitic element corresponding to the lower operating band are shaped like a part of a toroid skirting round the circular radiating part, which corresponds to the upper operating band. Also the major directions of the first and third radiating part can be considered to be substantially perpendicular to each other.

FIG. 11 shows an example of a radio device according to the invention. The radio device RD comprises an inner multiband antenna 100 congruent with the description above, marked with a dashed line in the drawing.

FIG. 12 shows an example of the matching of an antenna like the one shown in FIG. 3. The matching appears from the curve of the reflection coefficient S11 as a function of frequency. The measured antenna has been designed to operate in the US-GSM, EGSM, GSM1800 and GSM1900 systems. The frequency ranges required by these systems are respectively 824-894 MHz, 880-960 MHz, 1710-1880 MHz and 1880-1990 MHz. The lower operating band of the antenna then must cover the range 824-960 MHz, and the upper operating band must cover the range 1710-1990 MHz. These ranges are marked as B/and Bu in FIG. 12. It is seen from the curve that at the worst, the reflection coefficient is approx. −4 dB, and in most of the bands less than −6 dB. The four significant resonances of the antenna are seen from the shape of the curve. The lower operating band is based on the first resonance r1, which is primarily caused by the longer branch of the main element 320, and the third resonance r3, which is primarily caused by the longer branch of the parasitic element 330. The distance between the first and the third resonance frequency is a good 110 MHz. The upper operating band is based on the second resonance r2, which is primarily caused by the shorter branch of the main element, and the fourth resonance r4, which is primarily caused by the shorter branch of the parasitic element 330. The distance between the second and the fourth resonance frequency is about 230 MHz.

If a wide lower band is not required, the antenna structure can be dimensioned so that the frequency of the first resonance r1 falls on the transmitting band of the GSM900 system, for example, and the frequency of the third resonance r3 on the receiving band of this system.

Multiband antennas according to the invention have been described above. The shapes of the antenna elements can naturally differ from those presented, as long as the parts corresponding to at least one operating band have major directions, which are perpendicular to each other. In the examples presented, the part of the antenna corresponding to the main element is of the PIFA or monopole type. It can also be e.g. an IFA or ILA (Inverted L-Antenna), in which case the main element is more wirelike than planar. The antenna elements may also be shaped e.g. in a way that the antenna has three separate operating bands. The invention does not limit the manufacturing method of the antenna. The inventive idea can be applied in different ways within the scope defined by the independent claim 1.

1-14. (canceled)

15. A multiband antenna comprising:
a ground plane;
a main element comprising a first part and a second part, wherein the first part is adapted to form at least a portion of a first resonator, and wherein the second part is adapted to form at least a portion of a second resonator;
a parasitic element comprising a third part and a fourth part, wherein the third part is adapted form at least a portion of a third resonator, and wherein the fourth part is adapted to form at least a portion of a fourth resonator;
a feed conductor adapted to connect to the main element at a feed point; and
a first short-circuit conductor adapted to connect to the parasitic element at a first short-circuit point.

16. The multiband antenna of claim 15, further comprising a first band comprising the natural frequencies of both the first resonator and the third resonator, and a second band comprising the natural frequencies of both the second resonator and the fourth resonator, and
wherein a first slot separates the feed point from the first short-circuit point.

17. The multiband antenna of claim 16, further comprising a second short-circuit conductor connected to the main element at a second short circuit point;
wherein the first part of the main element is divided from the second part by a second slot.

18. The multiband antenna of claim 17, wherein the first part of the main element is longer than the second part, wherein the third part of the parasitic element is divided from the fourth part by a third slot, and wherein the third part of the parasitic element is longer than the fourth part.

19. The multiband antenna of claim 16, further comprising a second short-circuit conductor connected to the main element at a second short circuit point, wherein the first part of the main element comprises a first conductive surface, and wherein the second part of the main element comprises a second slot running through the first conductive surface.

20. The multiband antenna of claim 19, wherein the third part of the parasitic element comprises a second conductive surface, and the fourth part of the parasitic element comprises a third slot running through the second conductive surface.

21. The multiband antenna of claim 15, wherein the main element comprises a monopole type main element, and wherein at least a portion of the main element is positioned perpendicular to the ground plane.

22. The multiband antenna of claim 15, wherein the parasitic element comprises a monopole type parasitic element, and wherein at least a portion of the parasitic element is positioned perpendicular to the ground plane.

23. The multiband antenna of claim 16, wherein the first band comprises the frequency ranges of US-GSM and EGSM systems.

24. The multiband antenna of claim 16, wherein the second band comprises the frequency ranges of GSM1800 and GSM1900 systems.

25. The multiband antenna of claim 15, wherein the first and the second parts of the main element are positioned substantially perpendicular to the third and the fourth parts of the parasitic element.

26. The multiband antenna of claim 25, wherein one of the first part and the second part substantially encircles a free end of the other one, and wherein one of the third part and the fourth part substantially encircles a free end of the other one.

27. The multiband antenna of claim 16, wherein the first part of the main element is positioned substantially perpendicular to the third part of the parasitic element.

28. The multiband antenna of claim 16, wherein the second part of the main element is positioned substantially perpendicular to the fourth part of the parasitic element.

29. The multiband antenna of claim 15, wherein each of the main element and the parasitic element comprise at least one sheet of metal.

30. The multiband antenna of claim 15, wherein each of the main element and the parasitic element comprise a conductive area on the surface of a circuit board.

31. An apparatus comprising:
a ground plane;
a main element comprising a first part and a second part, wherein the first part is adapted to form at least a portion of a first resonator, and wherein the second part is adapted to form at least a portion of a second resonator;
a parasitic element comprising a third part and a fourth part, wherein the third part is adapted form at least a portion of a third resonator, and wherein the fourth part is adapted to form at least a portion of a fourth resonator;
a feed conductor adapted to connect to the main element at a feed point; and
a first short-circuit conductor adapted to connect to the parasitic element at a first short-circuit point.

32. The apparatus of claim 31, further comprising a first band comprising the natural frequencies of the first resonator and the third resonator, and a second band comprising the natural frequencies of the second resonator and the fourth resonator; and
wherein the main element is positioned substantially perpendicular to the parasitic element.

33. The apparatus of claim 31, further comprising a second short-circuit conductor connected to the main element at a second short circuit point.

34. The apparatus of claim 31, wherein the first part wraps at least partly around an end of the second part.

35. The apparatus of claim 31, wherein the third part wraps at least partly around an end of the fourth part.

36. The apparatus of claim 31, wherein at least one of the main element and the parasitic element comprise a monopole type element.

37. The apparatus of claim 31, wherein at least a portion of the main element is positioned perpendicular to the ground plane.

38. The apparatus of claim 31, wherein at least a portion of the parasitic element is positioned perpendicular to the ground plane.

39. The apparatus of claim 32, wherein the first band comprises the frequency ranges of US-GSM and EGSM systems.

40. The apparatus of claim 32, wherein the second band comprises the frequency ranges of GSM1800 and GSM1900 systems.

41. An apparatus comprising:
a ground plane;
a main element comprising a first part and a second part each adapted to resonate at separate frequencies;
a parasitic element comprising a third part and a fourth part each adapted to resonate at separate frequencies;
a feed conductor adapted to connect to the main element at a feed point; and
a first short-circuit conductor adapted to connect to the parasitic element at a first short-circuit point.

42. The apparatus of claim 41, further comprising a first band comprising the natural frequencies of the first and third parts, and a second band comprising the natural frequencies of the second and fourth parts;
wherein the first part is positioned substantially perpendicular to the third part; and
wherein the second part is positioned substantially perpendicular to the fourth part.

43. The apparatus of claim 42, wherein the feed point is separated from the first short-circuit point by a first width.

44. The apparatus of claim 43, wherein the first width comprises 0.2 millimeters.

45. The apparatus of claim 43, wherein the first width is no greater than a width of the same order of magnitude as one hundredth of the wavelength corresponding to the highest operating frequency of the apparatus.

46. The apparatus of claim 41, wherein the first part is longer than the second part.

47. The apparatus of claim 41, wherein the third part is longer than the fourth part.

48. The apparatus of claim 41, wherein one of the first part and the second part encircles at least a portion of a free end of the other one, and wherein one of the third part and the fourth part encircles at least a portion of free end of the other one.

49. An internal antenna having at least a lower and an upper operating band, comprising a ground plane, a radiating main element, a radiating parasitic element, an antenna feed conductor connected to the main element at a feed point, and a first short-circuit conductor connected to the parasitic element at a first short-circuit point, the main element comprising a first and a second radiating part, and the parasitic element comprising a third and a fourth radiating part, each radiating part having a major dimension of its own, wherein:
the first radiating part together with the surrounding parts of the antenna forming a first resonator having its natural frequency in the lower operating band of the antenna;
the second radiating part together with the surrounding parts of the antenna forming a second resonator having its natural frequency in the upper operating band of the antenna;
the third radiating part together with the surrounding parts of the antenna forming a third resonator having its natural frequency in the lower operating band of the antenna; and
the fourth radiating part together with the surrounding parts of the antenna forming a fourth resonator having its natural frequency in the upper operating band of the antenna;
said antenna further characterized in that:
at least the major dimensions of the radiating parts are substantially perpendicular to each other; and
the feed point is proximate to the first short-circuit point, and between the starting portion of the main element, as seen from the feed point, and the starting portion of the parasitic element, as seen from the first short-circuit point, comprises a slot, the width of which is at the most of the order of magnitude of one hundredth of the wavelength corresponding to the highest operating frequency of the antenna to create a sufficient coupling between the main and the parasitic element.

50. An antenna according to claim 49, further comprising a second short-circuit conductor connected to the main element at a second short-circuit point, characterized in that:
the main element comprises a slot starting from its edge and dividing it, as seen from the second short-circuit point, into two branches of different length, the first radiating part comprising the longer of these branches, and the second radiating part comprising the shorter of these branches, and
the parasitic element comprises a slot starting from its edge and dividing it, as seen from the first short-circuit point, into two branches of different length, the third radiating part comprising the longer of these branches, and the fourth radiating part comprising the shorter of these branches.

51. An antenna according to claim 49, further comprising a second short-circuit conductor connected to the main element at a second short-circuit point, wherein the main element has a slot starting from its edge, which slot comprises the second radiating part, and the first radiating part comprises the conductor plane of the main element.

52. An antenna according to claim 49, wherein the parasitic element has a slot starting from its edge, the slot comprising the fourth radiating part, and the third radiating part comprises the conductor plane of the parasitic element.

53. An antenna according to claim 49, wherein the main element is of the monopole type and is located at least in part on the side of the ground plane as seen in the direction of its normal.

54. An antenna according to claim 49, wherein the parasitic element is of the monopole type and is located at least in part on the side of the ground plane as seen in the direction of its normal.

55. An antenna according to claim 49, wherein the space between the natural frequencies of the first and the third resonator is such that the lower operating band covers the frequency ranges used by US-GSM and EGSM systems.

56. An antenna according to claim 49, wherein the space between the natural frequencies of the second and the fourth resonator is such that the upper operating band covers the frequency ranges used by the GSM1800 and GSM1900 systems.

57. An antenna according to claim 49, wherein the major dimensions of the radiating parts, which correspond both the lower and upper operating band, are substantially perpendicular to each other.

58. An antenna according to claim 49, wherein a longer branch of the main element at least partly encircles a free end of a shorter branch thereof, and a longer branch of the parasitic element at least partly encircles a free end of a shorter branch thereof.

59. An antenna according to claim 50, wherein only the major dimensions of the radiating parts which correspond the lower operating band, are substantially perpendicular to each other.

60. An antenna according to claim 50, wherein only the major dimensions of the radiating parts which correspond the upper operating band, are substantially perpendicular to each other.

61. An antenna according to claim 49, wherein the radiating elements comprise separate pieces of metal sheet.

62. An antenna according to claim 1, wherein the radiating elements comprise conductive areas on a surface of an antenna circuit board.

63. A method of operating a multiband antenna comprising a main element connected to a antenna feed conductor and a short-circuited parasitic element having a feed point proximate thereto, the method comprising:
exciting at least first and second resonances in said main element; and
exciting at least third and fourth resonances in said parasitic element;
wherein the frequencies of said first and second resonances and said third and fourth resonances fall within first and second different operating bands of the antenna, respectively.

64. The method of claim 63, wherein the first operating band of the antenna comprises the frequency ranges used by the US-GSM and the EGSM (Extended GSM) systems.
